(19) United States
(12) Patent Application Publication
(10) Pub. No.: US 2006/0048315 A1
(43) Pub. Date: Mar. 9, 2006

(54) Electric toothbrushes

(75) Inventors: John Geoffrey Chan, Maineville, OH (US); Douglas A. Gall, Strongsville, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/220,219

(22) Filed: Sep. 6, 2005

Related U.S. Application Data
(60) Provisional application No. 60/607,764, filed on Sep. 7, 2004.

(51) Int. Cl. A61C 17/22

(52) U.S. Cl. 15/22.1; 15/22.2

(57) ABSTRACT

An electric toothbrush is provided. The electric toothbrush has a handle, a head with first and second bristle holders and a longitudinal axis, and a neck disposed between the handle and the head. A motor is disposed within the handle. A shaft is operatively connected to the motor. The shaft pivots in a side-to-side direction and is operatively connected to the first and second bristle holders to move the second bristle holder in a side-to-side direction and to oscillate the first bristle holder about an axis generally perpendicular to the longitudinal axis of the head.

### CROSS REFERENCE TO RELATED APPLICATION

This application claims the benefit of U.S. Provisional Application No. 60/607,764 filed on Sep. 7, 2004, the substance of which is incorporated herein by reference.

### TECHNICAL FIELD OF THE INVENTION

The present invention relates to electric toothbrushes, and, more particularly, to toothbrushes having a shaft that pivots.

### BACKGROUND OF THE INVENTION

Electric toothbrushes utilizing various drive mechanisms are known in the art. However, there is a continuing desire to provide electric toothbrushes utilizing drive mechanisms that can provide multiple bristle holder movements, which are mechanically efficient, and/or which can provide smaller more compact arrangements.

### SUMMARY OF THE INVENTION

An electric toothbrush is provided. The electric toothbrush has a handle, a head with first and second bristle holders and a longitudinal axis, and a neck disposed between the handle and the head. A motor is disposed within the handle. A shaft is operatively connected to the motor. The shaft pivots in a side-to-side direction and is operatively connected to the first and second bristle holders to move the second bristle holder in a side-to-side direction and to oscillate the first bristle holder about an axis generally perpendicular to the longitudinal axis of the head.

### BRIEF DESCRIPTION OF THE DRAWINGS

While the specification concludes with claims directed to the invention, it is believed that the present invention will be better understood from the following description taken in conjunction with the accompanying drawings in which:

FIG. 1 is an exploded perspective view of an electric toothbrush made in accordance with the present invention;

FIG. 2 is a top plan view of the shaft, bushing and driven gear of the electric toothbrush of FIG. 1;

FIG. 3 is a side elevation view of the head of the toothbrush of FIG. 1;

FIG. 4 is a top plan view of the head of FIG. 3;

FIG. 5 is a top plan view of another embodiment of a head suitable for use with the toothbrush of FIG. 1;

FIG. 6 is a side elevational view of the first bristle holder of the toothbrush of FIG. 1; and

FIG. 7 is another side elevational view of the first bristle holder of FIG. 6.

### DETAILED DESCRIPTION OF THE INVENTION

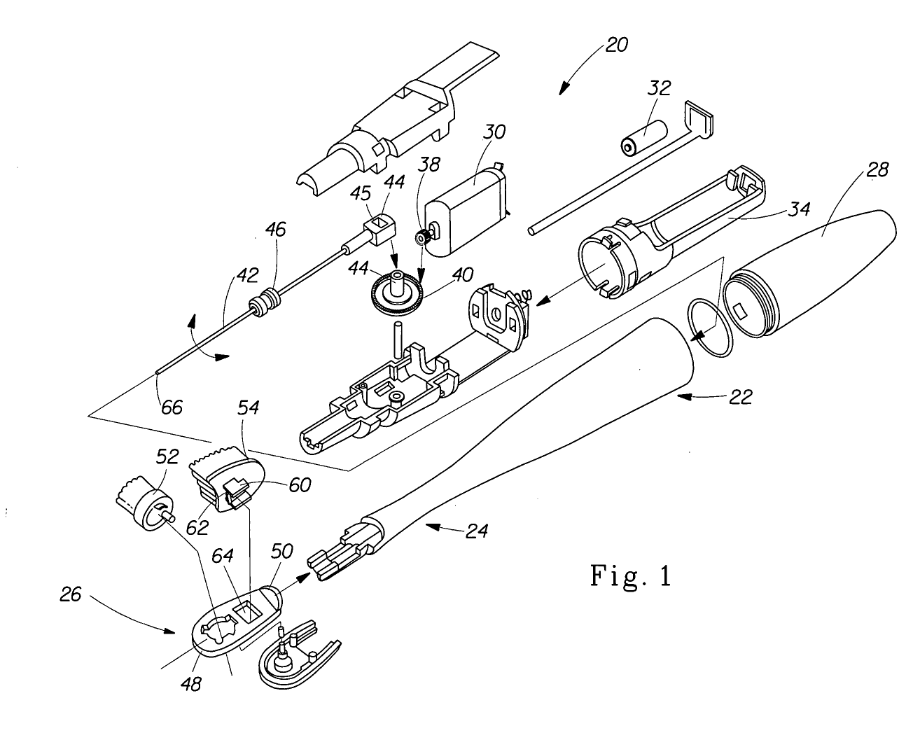

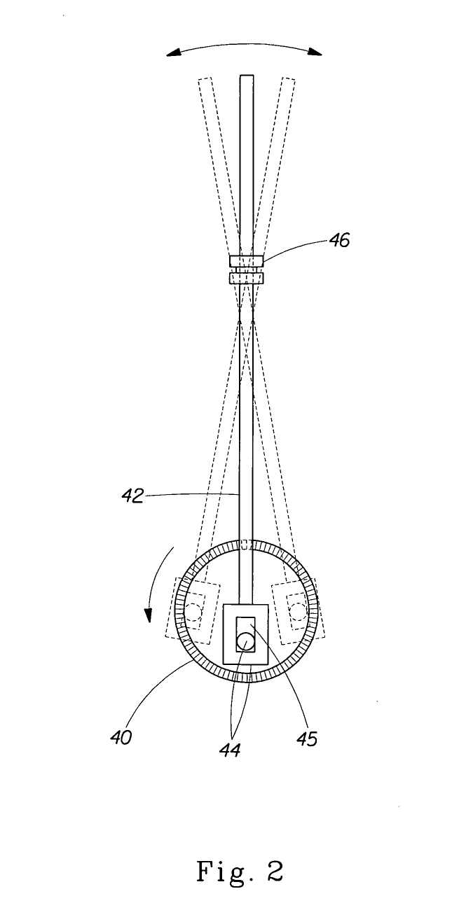

Reference will now be made to various embodiments of the present invention examples of which are illustrated in the accompanying drawings wherein like numerals indicate the same elements throughout the views. Referring to FIG. 1, an electric toothbrush 20 will now be described. The electric toothbrush 20 comprises a handle 22, a neck 24, and a head 26. The neck 24 may be integrally formed with the handle 22 or may be provided as a separate component. The handle 22 has a cap 28 that threadably engages a portion of the handle 22. An electric motor 30 is disposed within the handle 22 along with a voltage source. The voltage source can be provided in the form of one or more batteries 32 which are received in a cradle 34 that is disposed within the handle 22. The motor 30 has a rotatable output shaft and an output gear 38 attached to the rotatable output shaft. The output gear 38 engages a driven gear 40 which in turn is operatively connected to a shaft 42 having a coupling 44 with an elongated slot 45 that engages an eccentric post 44 of the driven gear 40. The slot 45 is aligned along the longitudinal axis of the shaft 42. The shaft includes a bushing 46 that is captured by the handle 22 or neck 24. The bushing 46 can be formed of any flexible material that allows the shaft 42 to pivot about the bushing 46. Suitable materials can include elastomeric polymers, such as natural or synthetic rubbers. The bushing 46 acts a pivot about which the shaft 42 moves. The location of the bushing 46 can be varied along the length of the shaft 42 in order to achieve a desired amount of side-to-side motion at the end of the shaft 42 adjacent the head 26. As the driven gear 40 rotates, the shaft 42 pivots about the bushing 46 in a side-to-side direction as best seen in FIG. 2. The side-to-side motion of the shaft 42 occurs substantially or entirely in a single plane.

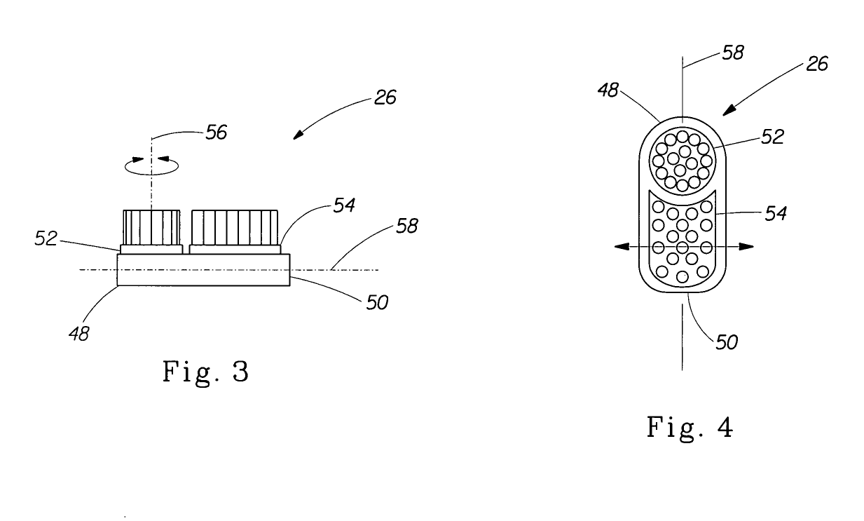

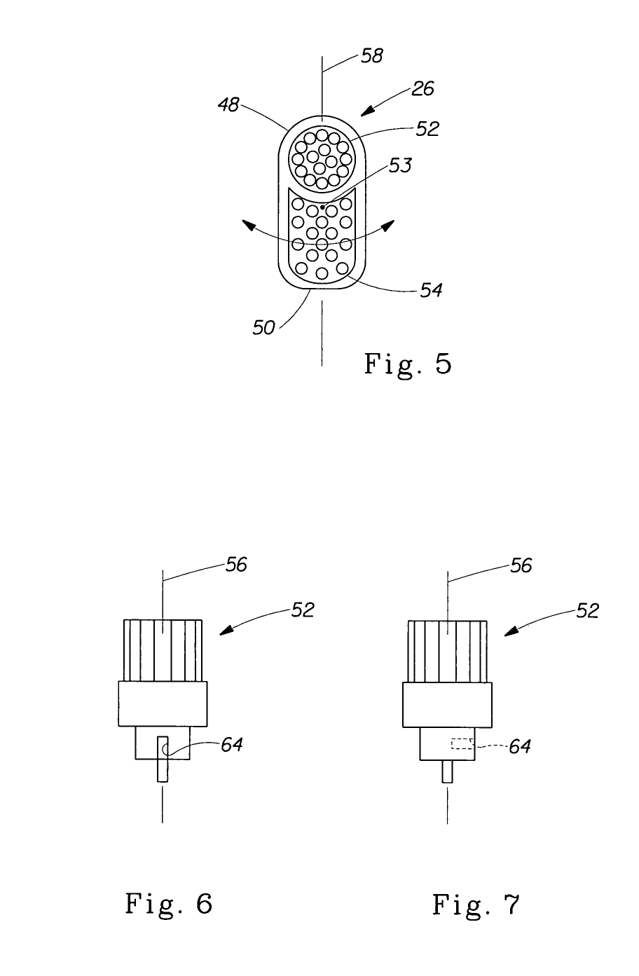

The head 26 has a first free end 48 and a second end 50 that engages the neck 24. The head includes one or more bristle holders. The electric toothbrush 20 comprises two bristle holders. A first bristle holder 52 is disposed adjacent the first end 48 and a second bristle holder 54 is disposed adjacent the second end 50. The first bristle holder 52 oscillates about an axis 56 that is substantially perpendicular to a longitudinal axis 58 of the head 26, as seen in FIG. 3. The second bristle holder 54 reciprocates in a side-to-side direction or motion perpendicular to the longitudinal axis of the head, as seen in FIG. 4. While the side-to-side motion shown in FIG. 4 is substantially perpendicular to the longitudinal axis 58 of the head 26, it is contemplated that other side-to-side motions of the second bristle holder 54 can be provided. For example, the second bristle holder 54 might swing or pivot about a pin or hinge 53. The pin or hinge could be provided at other locations on the second bristle holder 54, such as at either end or in the middle to provide different types motions in a side-to-side direction.

The shaft 42 passes through an extension 60 of the second bristle holder 54. The extension 60 has a hole 62 therein that receives a portion of the shaft 42. The extension 60 is received in slot 64 of the head 26 that guides the second bristle holder 54 in its side-to-side motion. The end 66 of the shaft 42 operatively engages a slot 64 (FIGS. 6 and 7) of the first bristle holder 52 to move the first bristle holder 52 in an oscillating motion about the axis 56.

It is significant to note that any of the features, aspects, or details of any method and/or product described herein can be combined, either entirely or partially, with any other feature, aspect, or detail of one or more other methods or products described herein. While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

All documents cited above are incorporated herein by reference; the citation of any document is not to be construed as an admission that it is prior art with respect to the invention.

What is claimed is:

1. An electric toothbrush, comprising:
a handle;
a head having first and second bristle holders and a longitudinal axis;
a neck disposed between said handle and said head;
a motor disposed within said handle; and
a shaft operatively connected to said motor, wherein said shaft pivots in a side-to-side direction and wherein said shaft is operatively connected to said first and second bristle holders to move said second bristle holder in a side-to-side direction and to oscillate said first bristle holder about an axis generally perpendicular to the longitudinal axis of said head.

2. The electric toothbrush according to claim 1, wherein said second bristle holder moves in a direction substantially perpendicular to said longitudinal axis of said second bristle holder.

3. The electric toothbrush of claim 1, wherein said second bristle holder further comprises a pivot and said first bristle holder moves in said side-to-side direction about said pivot.

4. The electric toothbrush of claim 1, further comprising a bushing, said shaft being received through and pivoting about said bushing.

5. The electric toothbrush of claim 4, wherein said bushing is made from an elastomeric polymer.

6. The electric toothbrush of claim 4, wherein a bottom surface of said first bristle holder and a bottom surface of said second bristle holder contact a top surface of said head.

7. The electric toothbrush of claim 4, wherein said second bristle holder comprises a depending element which passes through an aperture of said head.

8. The electric toothbrush of claim 4, wherein said bushing is oriented approximately about the center of a length of said shaft.

9. The electric toothbrush of claim 7, wherein said shaft engages said depending element of said second bristle holder and engages a portion of said first bristle holder.

10. The electric toothbrush of claim 7, wherein said second bristle holder is oriented between said first bristle holder and said neck.

11. The electric toothbrush of claim 7, wherein said second bristle holder is oriented between said first bristle holder and said neck.

12. The electric toothbrush of claim 1, wherein said handle comprises a single battery.

13. The electric toothbrush of claim 4, wherein said shaft pivots in said side-to-side direction in substantially a single plane.
